(19) United States
(12) Patent Application Publication
(10) Pub. No.: US 2012/0124358 A1
(43) Pub. Date: May 17, 2012

(54) CONFIGURATION INFORMATION RECOVERING SYSTEM AND METHOD

(75) Inventor: YAN LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/217,249

(22) Filed: Aug. 25, 2011

(30) Foreign Application Priority Data
Nov. 15, 2010 (CN) 201010544024.5

(51) Int. Cl. G06F 9/06

(52) U.S. Cl. 713/2

(57) ABSTRACT

A basic input output system (BIOS) microchip of a card and method recovers configuration information of the BIOS microchip of the card. The BIOS microchip of the card invokes a reading function from a BIOS microchip of a motherboard to read predetermined configuration information from the BIOS microchip of the motherboard. The BIOS microchip of the card replaces the configuration information stored in the BIOS microchip of the card by the predetermined configuration information, in response to a determination that the configuration information stored in the BIOS microchip of the card is different from the predetermined configuration information.

### BACKGROUND

1. Technical Field

Embodiments of the present disclosure relate to information processing technology, and particularly to a configuration information recovering system and method.

2. Description of Related Art

A computer card (e.g., a redundant array of independent disks (RAID) controller) can be inserted into an expansion slot of a computer motherboard to add functionality to a computer system. The computer card often includes a basic input output system (BIOS) microchip. The BIOS microchip may include configuration information of the computer. For example, the RAID controller embeds configuration information (e.g., RAID 0 configuration) in the BIOS microchip to manage one or more physical disk drives. However, in some situations, the configuration information stored in the BIOS microchip of the computer card may be ruined. Methods to recover the configuration information of the BIOS microchip of the computer card are desired by users.

### BRIEF DESCRIPTION OF THE DRAWINGS

FIG. 1 is a system view of one embodiment of a configuration information recovering system.

FIG. 2 is a block diagram of one embodiment of a BIOS microchip of a card stored in FIG. 1.

FIG. 3 is a flowchart of one embodiment of a configuration information recovering method.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

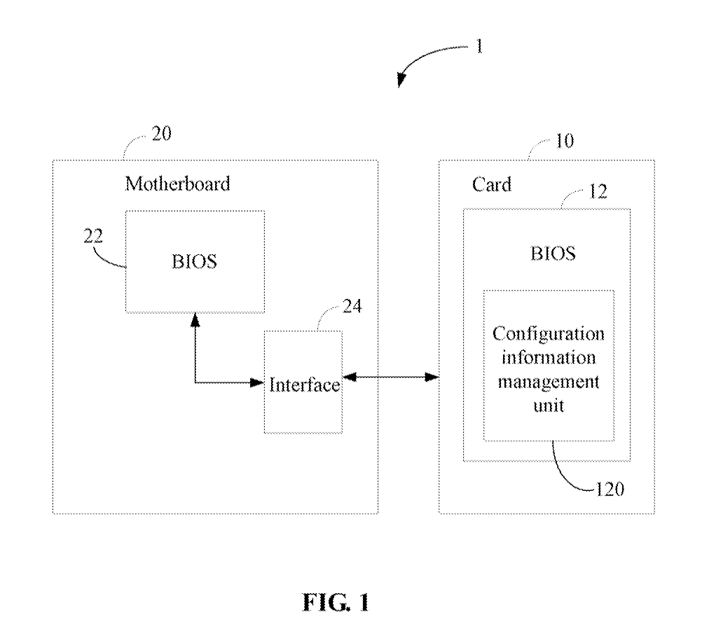

FIG. 1 is a system view of one embodiment of a configuration information recovering system 1. In one embodiment, the configuration information recovering system 1 may include a card 10 and a motherboard 20. The configuration information recovering system 1 may be used to recover configuration information in a basic input and output system (BIOS) microchip 12 of the card 10. The motherboard 20 includes a BIOS microchip 22 and an interface 24, and is connected to the card 20 via the interface 24.

Depending on the embodiment, the card 10 may be, but is not limited to, a redundant array of independent disks (RAID) controller or a graphics card (e.g., a video graphics array (VGA) card). The BIOS microchip 12 includes a configuration information recover unit 120. The BIOS microchip 22 may be, but not limited to, an extensible firmware interface (EFI) BIOS microchip. The configuration information may include setup information of the BIOS microchip 12. For example, if the card is the RAID controller, the configuration information may include the RAID 0 configuration, RAID 1 configuration, or RAID 5 configuration. If the card is the graphic card, the configuration may include BIOS setup configuration of the graphic card.

In one embodiment, the interface 24 may be, but is not limited to, a peripheral component interconnection (PCI). The BIOS microchip 22 stores predetermined configuration information. In one embodiment, the BIOS microchip 22 may be, but not limited to, an extensible firmware interface (EFI) BIOS microchip. The BIOS microchip 22 has a runtime service. The runtime service includes a setting function (e.g., SetVariable( ) and a reading function (e.g., GetVariable( ). The predetermined configuration information is configuration information of the card 10 and is saved by the BIOS microchip 12. In one embodiment, the BIOS microchip 12 invokes the SetVariable( ) to save the configuration information stored in the BIOS microchip 12 into the BIOS microchip 22. If the configuration information stored in the BIOS microchip 12 ruins, the BIOS microchip 12 can recover the configuration information from the BIOS microchip 22.

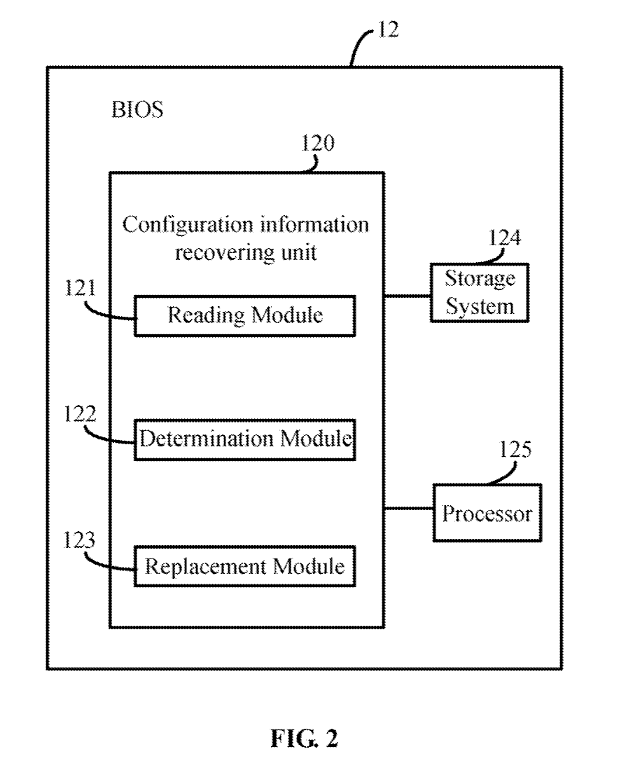

FIG. 2 is a block diagram of one embodiment of the BIOS microchip 12 including a configuration information recover unit 120. The configuration information recover unit 120 may be used to recover the configuration information of the BIOS microchip 12. In one embodiment, the computer 2 includes a storage system 124, and at least one processor 125. In one embodiment, the configuration information recover unit 120 includes a reading module 121, a determination module 122, and a replacement module 123. The modules 121-123 may include computerized code in the form of one or more programs that are stored in the storage system 124. The computerized code includes instructions that are executed by the at least one processor 125 to provide functions for modules 121-123. The storage system 124 may be an EPROM or a flash.

The reading module 121 invokes the reading function from the BIOS microchip 22 to read the predetermined configuration information from the BIOS microchip 22. In one embodiment, the reading module 121 invokes the GetVariable( ) to read the predetermined configuration information.

The determination module 122 determines if configuration information stored in the BIOS microchip 12 is the same as the predetermined configuration information. In one embodiment, assuming that the predetermined configuration information is RAID 0 configuration, if the configuration information stored in the BIOS microchip 12 is RAID 0 configuration, the configuration information store in the BIOS microchip 12 is the same as the predetermined configuration information. If the configuration information stored in the BIOS microchip 12 is not RAID 0 configuration, the configuration information stored in the BIOS microchip 12 is different from the predetermined configuration information.

The replacement module 123 replaces the configuration information stored in the BIOS microchip 12 by the predetermined configuration information, in response to a determination that the configuration information stored in the BIOS microchip 12 is different from the predetermined configuration information.

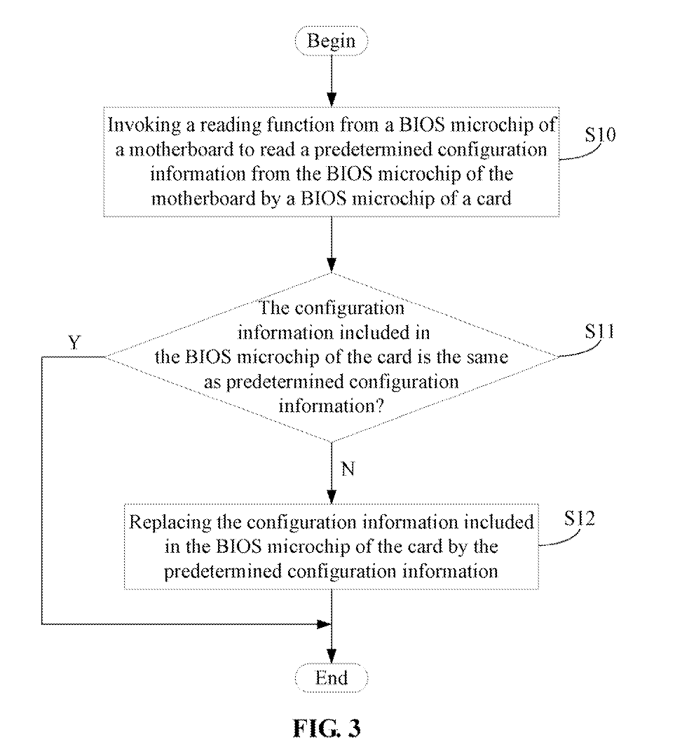

FIG. 3 is a flowchart of one embodiment of a configuration information recovering method. Depending on the embodiment, additional blocks may be added, others deleted, and the ordering of the blocks may be changed.

In block S10, the reading module 121 invokes the reading function from the BIOS microchip 22 to read the predetermined configuration information from the BIOS microchip 22. As mentioned above, the reading module 121 invokes the GetVariable( ) to read the predetermined configuration information.

In block S11, the determination module 122 determines if configuration information stored in the BIOS microchip 12 is the same as the predetermined configuration information. In one embodiment, assuming that the predetermined configuration information is RAID 0 configuration, if the configuration information stored in the BIOS microchip 12 is RAID 0 configuration, the configuration information stored in the BIOS microchip 12 is the same as the predetermined configuration information, the procedure goes to end. If the configuration information stored in the BIOS microchip 12 is RAID 5, the procedure goes to the block S12.

In block S12, the replacement module 123 replaces the configuration information stored in the BIOS microchip 12 by the predetermined configuration information.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A basic input output system (BIOS) microchip of a card, comprising:
a storage system;
at least one processor; and
one or more programs stored in the storage system and being executable by the at least one processor, the one or more programs comprising:
a setting module operable to invoke a reading function from a BIOS microchip of a motherboard to read predetermined configuration information from the BIOS microchip of the motherboard;
a determination module operable to determine if configuration information stored in the BIOS microchip is the same as the predetermined configuration information; and
a replacement module operable to replace the configuration information stored in the BIOS microchip of the card by the predetermined configuration information, in response to a determination that the configuration information stored in the BIOS microchip of the card is different from the predetermined configuration information.

2. The computer of claim 1, wherein the BIOS microchip of the card and the BIOS microchip of the motherboard are an extensible firmware interface (EFI) BIOS microchip.

3. The computer of claim 1, wherein the reading function is a GetVariable( ) function.

4. The computer of claim 1, wherein the card is a redundant array of independent disks (RAID) controller or a graphic card.

5. A configuration information recovering method implemented by a basic input output system (BIOS) microchip of a card, the method comprising:
invoking a reading function from a BIOS microchip of a motherboard to read predetermined configuration information from the BIOS microchip of the motherboard;
determining if the configuration information stored in the BIOS microchip is the same as the predetermined configuration information; and
replacing the configuration information stored in the BIOS microchip of the card by the predetermined configuration information, in response to a determination that the configuration information stored in the BIOS microchip of the card is different from the predetermined configuration information.

6. The method of claim 5, wherein the BIOS microchip of the card and the BIOS microchip of the motherboard are an extensible firmware interface (EFI) BIOS microchip.

7. The method of claim 5, wherein the reading function is a GetVariable( ) function.

8. The method of claim 5, wherein the card is a redundant array of independent disks (RAID) controller or a graphic card.

9. A non-transitory computer-readable medium having stored thereon instructions that, when executed by a basic input output system (BIOS) microchip of a card, causing the computer to perform a configuration information recovering method, the method comprising:
invoking a reading function from a BIOS microchip of a motherboard to read predetermined configuration information from the BIOS microchip of the motherboard;
determining if the configuration information stored in the BIOS microchip is the same as the predetermined configuration information; and
replacing the configuration information stored in the BIOS microchip of the card by the predetermined configuration information, in response to a determination that the configuration information stored in the BIOS microchip of the card is different from the predetermined configuration information.

10. The medium of claim 9, wherein the BIOS microchip of the card and the BIOS microchip of the motherboard are an extensible firmware interface (EFI) BIOS microchip.

11. The medium of claim 9, wherein the reading function is a GetVariable( ) function.

12. The method of claim 9, wherein the card is a redundant array of independent disks (RAID) controller or a graphic card.
